(19) United States
(12) Patent Application Publication
(10) Pub. No.: US 2010/0132229 A1
(43) Pub. Date: Jun. 3, 2010

(54) Powered Implement Machine

(76) Inventor: Michael Chahino, Geneva, IL (US)

Correspondence Address: Erickson Law Group, PC, 1749 S. NAPERVILLE ROAD, SUITE 202, WHEATON, IL, 60189, US

(21) Appl. No.: 12/467,904

(22) Filed: May 18, 2009

Related U.S. Application Data
(60) Provisional application No. 61/053,893, filed on May 16, 2008.

(51) Int. Cl. E01H 5/00; A01B 45/02; A01B 45/00

(52) U.S. Cl. 37/241

(57) ABSTRACT

A user-walk-behind self-propelled implement machine having a frame, a motor, a handle, and a plurality of wheels. The machine may operate one of a plurality of implements, including a shovel blade, a hitch, an aerator, a dethatcher, a lawn sweeper, a spreader, a wheel barrow, or a lawn mower. The implement may also be a sweeping brush, and wherein the brush is driven to rotate by a belt attached to the motor. The machine has a receiver to connecting the implement to the frame. The motor drives axles. Tiller tines or wheels are connected to the axles. When the implement is a shovel, a user operates the shovel by engaging the motor and steering the shovel to plow snow from a surface.

This application claims the benefit of U.S. Provisional Patent Application No. 61/053,893 filed on May 16, 2008.

### FIELD OF THE INVENTION

The invention relates to motorized machines for operating an implement, such a shovel blade, a hitch, an aerator, a dethatcher, a lawn sweeper, a spreader, a wheel barrow, a sweeping brush, or a lawn mower.

### BACKGROUND OF THE INVENTION

It is desirable to remove snow from trafficked areas during and after a snow fall. These trafficked areas may include sidewalks, patios, decks, driveways, roads, or parking lots.

Several devices exist to remove snow including snow blowers and traditional manual shovels. Snow blowers generally use an impeller or auger to both move the snow into the machine and force it out the discharge chute, throwing the snow to another location. The traditional manual shovel has a blade attached to a handle.

These devices each have disadvantages. The traditional manual shovel requires great physical effort and may cause back strain or injury for a user. Traditional snow blowers and other implement machines are often bulky and do not work well when there is only a slight amount of snow accumulation. Heavy snow blowers may be difficult for certain users to operate.

The present inventor recognizes the need for a light weight, maneuverable, safe, and easy to operate device for moving materials including snow. The inventor also recognizes it would be desirable to have such a device having a removable implement and capable of operating one of a number of implements including a hitch, an aerator, a dethatcher, a lawn sweeper, a spreader, a wheel barrow, a sweeping brush, or a lawn mower. The inventor also recognizes the need for a device that is more maneuverable than a traditional snow blower or implement machine, but that does not require the physical effort of a manual shovel or implement. The inventor further recognizes the need for a device that works with all types of snow and all amounts of snow accumulation. The inventor recognizes a need for a device that has fewer wearable parts than a traditional snow blower or implement machine. The inventor also recognizes a need for a device that is easily operated by users of various ages.

### SUMMARY OF THE INVENTION

The invention provides a user-walk-behind implement machine. The machine has a frame with a front and a rear and a motor connected to the frame and driving a pair of laterally spaced apart drive wheels. The machine has a receiver connected to a front portion of the frame in an area of the frame located between the drive wheels. The machine has an implement detachably connected to the receiver and a handle connected to the frame and extending away from the rear of the frame.

A motor control may be mounted to the handle for regulating the speed of the motor. The handle may also comprise a gear box control for regulating a gear ratio of the gearbox.

In one embodiment, the machine has at least one rear wheel located to the rear of the drive wheels. The at least one rear wheel connected to a height adjustment mechanism configured to adjust the vertical position of the implement.

In one embodiment, the machine has at least two laterally spaced apart wheels located to the rear of the drive wheels.

In one embodiment, the machine has a height adjustment mechanism configured to pivot at least a portion of the frame about an axis of the drive wheels to adjust the vertical position of the implement.

In one embodiment, the machine has a rear axle connected to an upwardly extending axle mount. The machine has a pair of laterally spaced apart rear wheels connected to the axle. The height adjustment mechanism comprises an axle mount receiver. The receiver has a lock for releasably securing the receiver along the axle mount.

In one embodiment, the implement is a shovel. The shovel has an arm detachably connected to the receiver, a pivot mount, and pivotable blade. The pivot mount is configured to locate the blade at one of a plurality of positions relative to the arm. The arm has a blade mount opposite an end connected to the receiver. The blade mount comprises a plurality of blade mount holes. The pivot mount comprises at least one pivot mount hole aligned with one blade mount hole and a locking pin inserted through the aligned holes to secure the blade in a vertical position relative to the arm. A user operates the shovel by engaging the motor and steering the shovel to plow snow from a surface.

In one embodiment, the blade has a centered position and a maximum pivotable range being 15 degrees in either direction from the center.

The implement may be a hitch, an aerator, a dethatcher, a lawn sweeper, a spreader, a wheel barrow, or a lawn mower. The implement may also be a sweeping brush, and wherein the brush is driven to rotate by a belt driven by the motor.

In one embodiment, the receiver comprises an anchor and a stop. The implement has a latch configured to secure the implement to the receiver. The latch has a pivotable hook attached to a lever. The latch has a locked position. The lever engages the stop and the lever presses the hook into the anchor when the latch is in a locked position.

In one aspect of the embodiment, the handle extends behind the motor and the implement extends in front of the motor.

In one aspect of the embodiment, the wheels contact a surface to be action by the implement and the handle is operated by a user that is standing on the surface.

Numerous other advantages and features of the present invention will become readily apparent from the following detailed description of the invention and the embodiments thereof, and from the accompanying drawings.

### BRIEF DESCRIPTION OF THE DRAWINGS

FIG. 1 is a front perspective view of the machine with a shovel implement;

FIG. 2 is a perspective view of a gear box;

FIG. 3 is a schematical side view of the machine with the housing removed;

FIG. 4 is a rear perspective view of the machine;

FIG. 5 is a side view of an alternative embodiment of the machine with a shovel implement;

FIG. 6 is a perspective view the alternative embodiment with the implement, rear wheels, and over removed;

FIG. 7 is a perspective view of the arm of the shovel implement;

FIG. 8 is a perspective view of the shovel implement;

FIG. 9 is a perspective view of a dethatcher implement;

FIG. 10 is a perspective view of a brush implement;

FIG. 11 is a perspective view of an aerator implement;

FIG. 12 is a perspective view of a lawn sweeper implement;

FIG. 13 is a perspective view of a hitch implement;

FIG. 14 is a perspective view of a mower implement;

FIG. 15 is a perspective view of a spreader implement; and

FIG. 16 is a perspective view of the alternative embodiment with tiller tines in place of the wheels.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

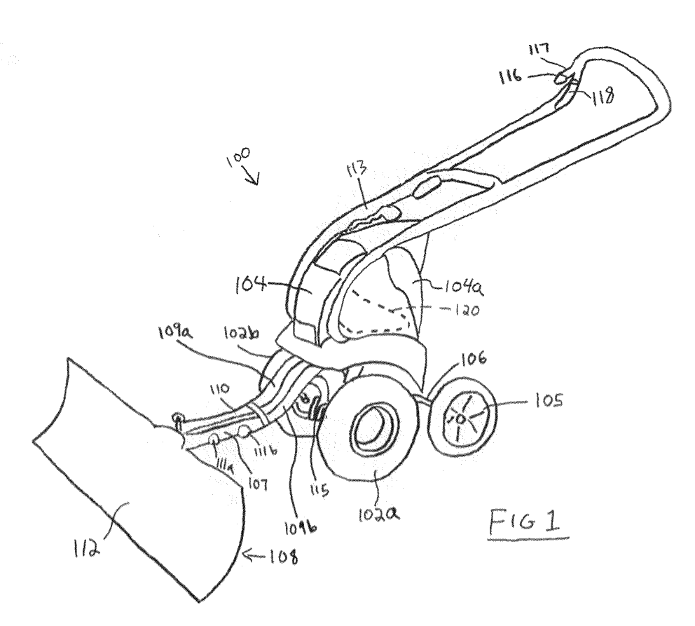

FIG. 1 shows a perspective view of an embodiment of the implement machine 100. The implement machine has a frame 120. The motor 103 is mounted to the frame 120. The motor 103 may comprise an electric AC motor, an electric DC motor, a gas motor, or other motor. A housing 104 covers the motor 103. The motor 103 is connected to a gear box or transmission 115.

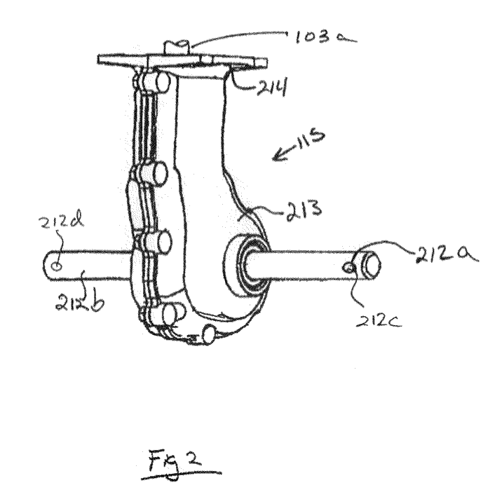

FIG. 2 shows the gear box 115 comprises a pair of drive shafts 212a, 212b, a housing 213, and a gear box mount 214. A gear arrangement is provided within the gear box to redirect and transmit rotary power from the vertical drive shaft of the motor to the horizontal drive shafts 212a, 212b. The drive shafts 212a, 212b connect to a pair of front wheels 102a, 102b. Retaining pin holes 212d, 212c are located at the ends of the drive shafts 212b, 212a respectively. Retaining pins 1602 are inserted through the retaining pin holes 212d, 212c to hold the wheels onto the shafts. The gear box 115 drives at least one of the front wheels 102a, 102b when the motor and gear box are in rotary power communication. The front and rear wheels support the implement machine 100 on a surface or the ground.

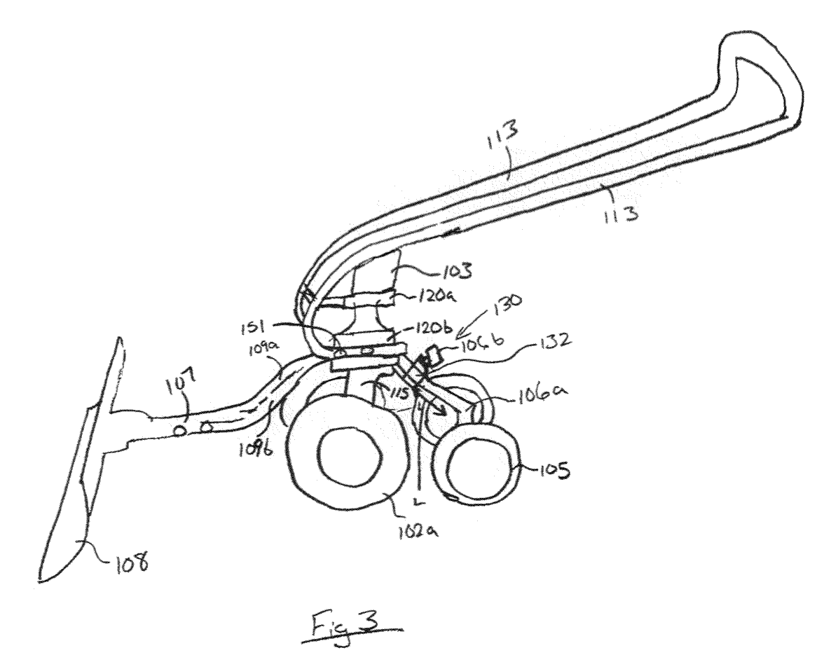

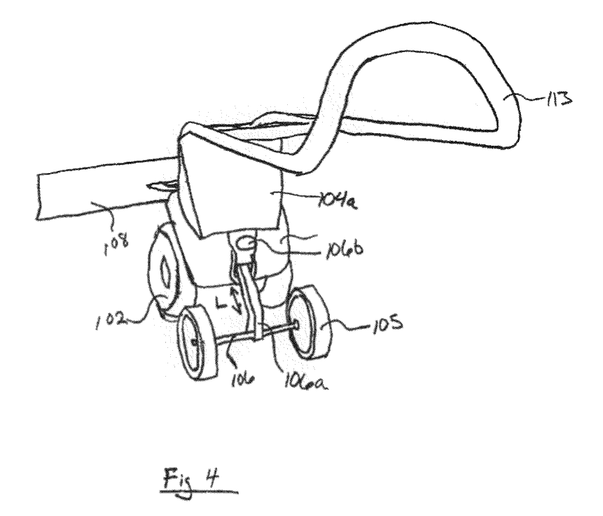

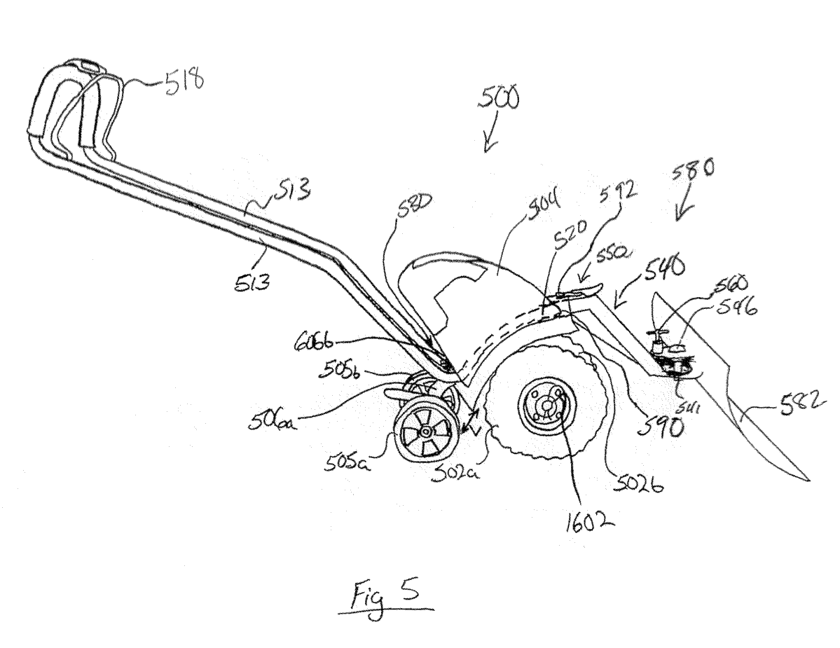

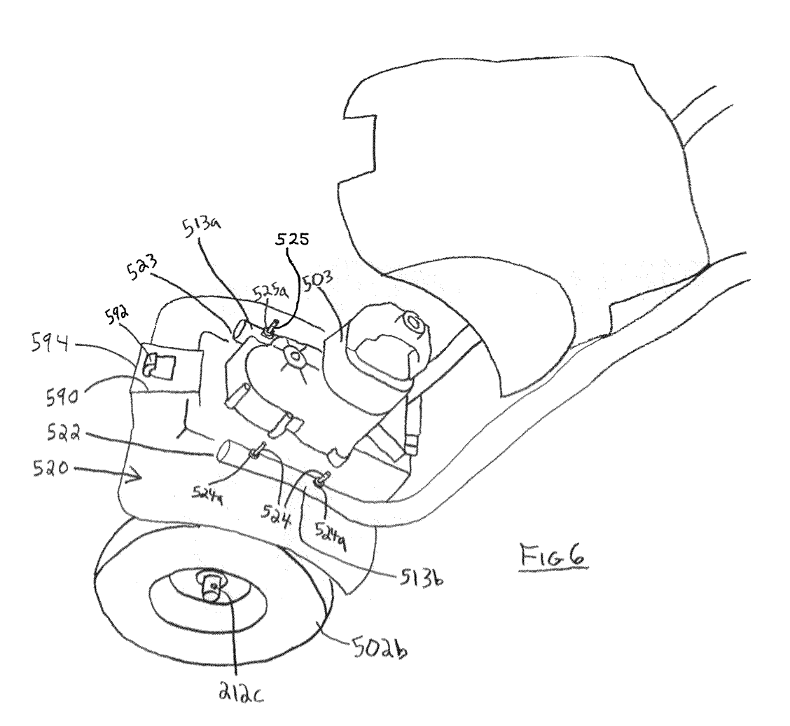

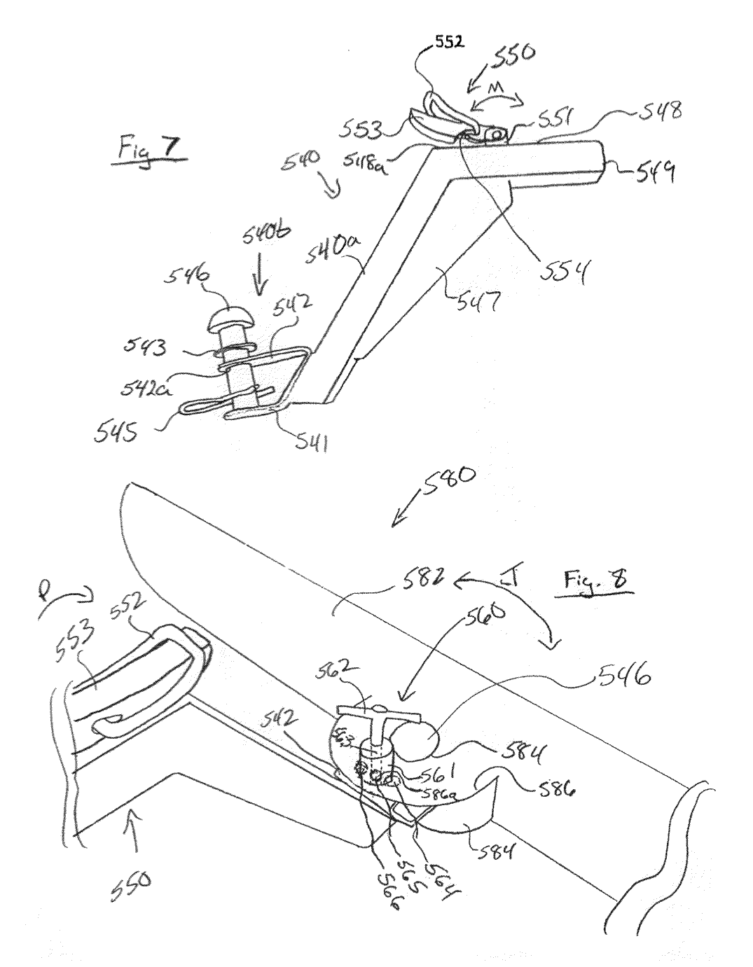

FIG. 3 is schematical side view of the implement machine with the housing 104 removed. In one embodiment, the motor is mounted to a first frame mount 120a. The gear box mount 214 (FIG. 2) connects the gear box 115 to the frame on the lower side of a second frame mount 120b. The second frame mount 120b comprises a hole 103a for the motor output shaft (FIG. 4) to connect through to the gearbox 115. The first frame mount 120a and the second frame mount 120b are connected to a pair of tubular handles 113 that complete the frame.

Referring to FIG. 4, a pair of rear wheels 105 connect to an axle 106. The axle 106 is connected to the frame in a manner that allows the wheels to rotate. In one embodiment, the implement machine provides a blade height adjustment mechanism 130 in the L direction. The blade height adjustment mechanism 130 has a receiver 132 that slidably receives a 106a axle mount, a locking mechanism 106b for securing the axle mount relative to the receiver 132. The receiver 132 is connected to the frame. The axle 106 is connected to the frame by the axle mount 106a. The locking mechanism may comprise an adjustable screw 106b. The contact point between the axle mount 106a and the frame is adjustable with the adjustment screw 106b. In another embodiment, the screw is threaded through the receiver 132 and when the screw is tightened it applies pressure on the axle mount, securing the axle mount against the receiver. In another embodiment, the axle mount comprises a plurality of holes. The screw is then selectively inserted through the frame into a selected hole.

Connecting the axle mount 106a to the receiver at a point on the axle mount farther from the axle tilts the implement machine in a forward direction. Connecting the axle mount 106a to the frame at a point closer to the axle tilts the implement machine in a rearward direction. Adjusting the contact point adjusts the vertical location of the blade with respect to the ground.

A plow blade mount 107 is attached to and extends forward from the frame. A plow blade 108 connects to the frame by connection with the plow blade mount 107. In one embodiment, the plow blade 108 connects to a connection shaft 110. The plow blade mount 107 comprises two elongated shafts 109a, 109b. The connection shaft 110 is connected between the elongated shafts 109a, 109b with bolts 111a, 111b. The plow blade 108 is connected to the connection member 107 so that the face 112 of the plow blade faces away from the implement machine 100. Bolts 151 connect the elongated shafts 109a, 109b and the handle 113 to the frame 120b.

The implement machine may comprise a frame and structure such as disclosed in U.S. Pat. No. 7,237,620, which is incorporated by reference. The tine assemblies of the '620 patent are replaced with the front wheels 102 of the implement machine. The plow blade mount 107 is attached to the upper flange 104 of the '630 patent. The elongated shafts 109a, 109b connect within the horizontally disposed annular recesses 114, 116 of the '630 patent respectively. The elongated shafts 109a, 109b may also connect to the support portions 120, 122 of the handle 18 of the '620 patent.

In one embodiment, a handle 113 is connected to the frame and extends upward and away from the implement machine 100. The handle extends in a direction opposite a plow blade end of the implement machine 100. The handle may comprise any object capable of controlling the direction of or steering the implement machine, including for example, a steering wheel with an accompanying steering mechanism.

In one embodiment, a motor start button 116 and or a motor throttle control 117 are attached to the handle and connected to the motor 103. The handle may also have a kill switch 118, 518 that must be held in a depressed position by the operator while the implement machine is in operation. Releasing the kill switch 118, 518 will stop the motor 103. In another embodiment, a gear box control may be mounted on the handle, allowing the user to adjust a gear ratio of the gear box.

FIG. 5 shows an alternative embodiment of the implement machine 500. The machine includes a frame 520. The frame supports the motor 503 (FIG. 6). The motor is covered by a housing 504. The motor connected to a gear box or transmission (not shown), which is configured similarly to gear box 115. The transmission is connected to a pair of drive wheels 502a, 502b.

A tubular handle 513 is connected to the frame and extends upward and away from the rear of the frame. A pair of rear wheels 505a, 505b connect to an axle 212a. The axle is connected to the gear box.

The implement machine provides a blade height adjustment mechanism 530 in the L direction. The blade height adjustment mechanism 530 is the same as provided in the blade height adjustment mechanism 130. The blade height adjustment mechanism 530 has a receiver (not shown) that slidably receives a 606a axle mount, and a locking mechanism 606b for securing the axle mount relative to the receiver. The receiver is connected to the frame. The axle is connected to the frame by the axle mount 506a.

Connecting the axle mount 506a to the receiver at a point on the axle mount farther from the axle tilts the implement machine in a forward direction. Adjusting the contact point between the receiver and the axle mount 106a adjusts the vertical location of the implement with respect to the ground. Connecting the axle mount 106a to the receiver at a point closer to the axle tilts the implement machine in a rearward direction.

FIG. 6 shows the machine 500 with the housing removed. The frame 220 is a solid unit. The handle ends 513a, 513b are secured to handle slots 522, 523 respectively. The handle ends 513a, 513b are secured to the handle slots 522, 523 by studs 524 and 525 (the rear stud not shown). The studs are secured to the frame and penetrate the handle ends. The handle ends are fastened to the studs with nuts 524a, 525a. The motor 505 is mounted to the frame. The gear box 115 is attached to the motor. In one embodiment the gear box is attached to the frame.

The machine 500 has an implement receiver 590 for attaching an implement. FIG. 5 shows the implement as a shovel 580. The shovel 580 has a support arm 540, a locking mechanism 550, and a blade 582.

FIGS. 6 and 7 show the shovel 580. The arm 540 is connectable to the receiver 590 at the receiver end 549 of the arm 540. A lever is pivotably connected to the mount 551 and pivotable about the axis of connection along the arc M of FIG. 7. A hook 552 is pivotably connected to the lever in a hock hole 554. The hook is pivotable about the axis of connection along the arc P of FIG. 8.

To secure the arm 540 to the machine 500, the receiver end 549 slides into the receiver 590 until the locking mechanism mount 551 and/or support brace 547 contact the receiver face 594. The lever 553 and the hook 552 are pivoted toward an anchor 592 of the receiver 590. After the hook is extended over and down in front of the anchor 592, the lever is pulled away from the receiver and toward the surface 548a of the arm creating a secure pressured connection between the locking mechanism mount 551 and/or support brace 547 on one side and the receiver face 594 on the other. The support brace also provides structural strength to the support arm 540.

The support arm has a flat upper surface 548, an angled portion 540a, and a blade mount portion 540b. The blade mount portion 540b has an upper arm mount 542 and a lower arm mount 541. The upper mount has a pin hole 542a for receiving an anchoring pin 546. A washer 543 may be placed between the pin head and the upper mount 542. The pin 546 penetrates the hole 542a and may rest on the upper surface of the lower mount 541. The pin has a retaining pin hole (not shown) for receiving a retaining pin 545. The retaining pin 545 prevents the pin from being withdrawing through the hole 542a of the upper mount 542. In another embodiment, the lower mount has a hole aligned with the hole 542a and the pin 546 extends through the hole of the lower mount. The retaining pin 545 is secured in the pin 546 at a position below the lower mount 541.

As shown in FIG. 8, the blade 582 has an upper blade mount 586 and a lower blade mount 584. The upper blade mount 584 is positioned on the upper arm mount 542 and the lower blade mount 586 is below the lower arm mount 541. The pin 546 connects the blade to the blade mount portion 540b when a upper blade mount hole 584 is aligned with the pin hole 542a of the upper arm mount 542. The blade is pivotable about an axis of the pin 546 along the arc T of FIG. 8.

The upper blade mount has a pivot locking mechanism 560. The locking mechanism 560 has a spring retainer 561 that holds a spring (not show) that biases a pivot locking pin 563 in the downward direction. The spring retainer 561 has a stop (not shown) that prevents the locking pin 563 from being completely withdrawn from the spring retainer. The pin has a T handle 562 extending above the spring retainer 561. The upper arm mount 542 has a plurality of pivot locking holes 546, 565, 566. The upper blade mount 548 has one blade lock hole 548a that is alignable with one of the pivot locking holes by pivoting the blade about the axis of pin 546. The spring retainer and the pin 563 are positioned over the blade lock hole 548a.

In one embodiment, the outermost pivot locking holes 546, 566 position the blade at a maximum of 15 degree angle from center in either direction about the axis of the pin 546. This 15 degree angle provide optimal displacement of snow to the side of the blade in which the blade is angled. The blade is at a center position is when the blade is perpendicular to the arm 540a.

The receiver 590 of the machine 500, 100, is adapted to receive many types of implements. FIGS. 9 through FIG. 15 show a number of implements attachable to the machine.

A dethatcher 900, such as those used on ground, turf, or soil is shown in FIG. 9. The dethatcher has a first row of tines 908 and a second row of tines 904. Each tine has an angled end 906. The tines are connected to a support 902. The tines are flexible and/or flexibly attached to the support such as disclosed in U.S. Pat. No. 7,073,317, which is incorporated by reference. The support is supported by wheels 912. The support connects to the receiver 590 with an arm 910. The connection of the arm to the receiver is similar to that of arm 540 having a locking mechanism 550. The machine 500, 100 pushes the dethatcher and the tines flex and penetrate the ground, turf or soil.

A sweeper or brush 1000 is shown in FIG. 10. The brush as a plurality of bristle groups 1002 containing a number of flexible bristles. While bristle groups are shown, the bristles need not be grouped. The bristles may be any flexible material, such as plastic or metal. The bristles are connected a rotator 1004. An arm 1014 is connected to the rotator by a hub 1008. In one embodiment, the rotator is driven to rotate by a belt 1006 connected to a power-take-off connection (not shown) connected to the output of the motor 503, 103. The rotator is configured to rotate in a counterclockwise direction as shown by direction V in FIG. 10. The brush 1000 has a shield or guard 1010 to prevent material from being thrown in the direction of the machine operator. The shield has a front extending portion 1012. The connection of the arm to the receiver is similar to that of arm 540 including the locking mechanism 550.

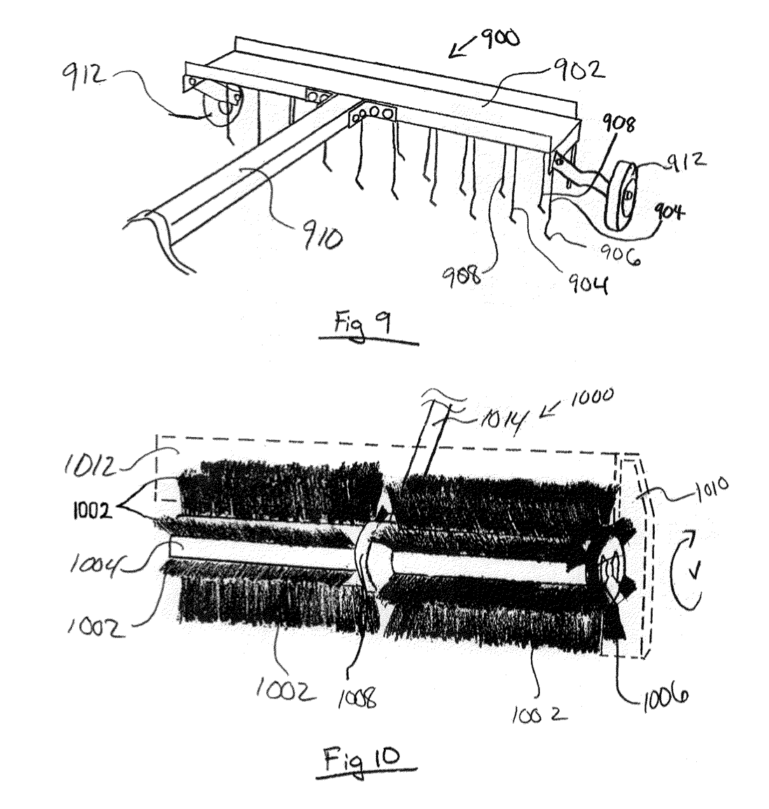

An aerator 1110, such as those used on ground, turf, or soil is shown in FIG. 11. The aerator has a support 1110 with side plates 1114. A rotating axle 1102 is rotatably attached to the side plates 114. A plurality of star wheels 1104 are fixed to and rotate with the axle 1102. As star wheel has a plurality of spikes 1106 extending radially from the star wheel. In one embodiment, the frame is supported by wheels 1116. Wheel height is adjustable to adjust the vertical location of the spikes relative to the ground. The aerator attaches to the machine 500, 100 by an arm 1112. The machine pushes the aerator in the I direction of FIG. 11. As the aerator move in the I direction the spikes 1106 penetrate the ground as the star wheels rotate. The connection of the arm to the receiver is similar to that of arm 540 including the locking mechanism 550.

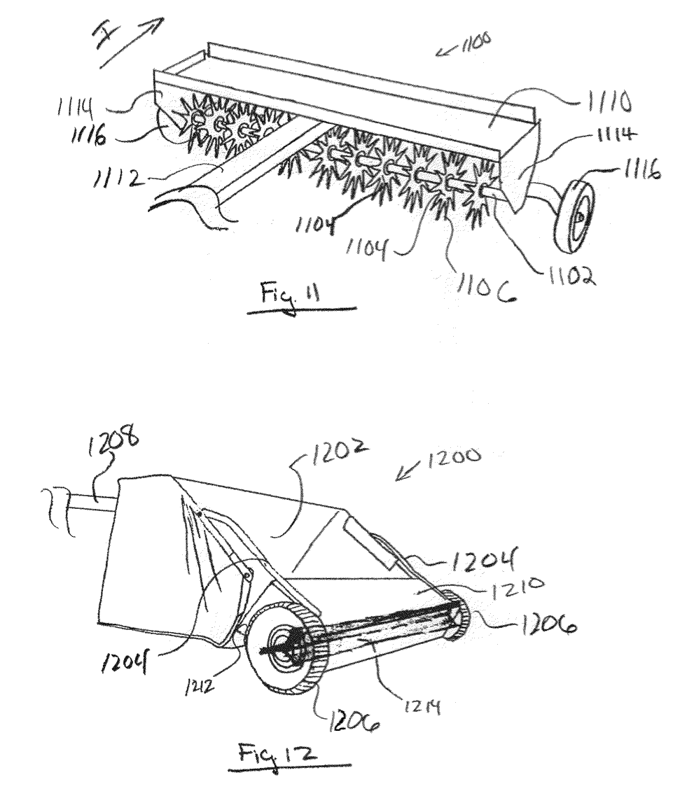

A lawn sweeper 1200 is shown in FIG. 12. In one embodiment, the lawn sweeper is that disclosed in U.S. Pat. No. 3,597,786, which is incorporated by reference. The sweeper has a front cover 1210 connected to a frame (not shown), and two side portions 1212 on opposite side of the front cover, and hopper support arms 1204. Wheels 1206 are rotatably attached to the side portions. A brush 1214 extends between the side portions and is driven by a gear or pulley connection to axles extending from the wheels. The brush rotates to throw material from the ground into a hopper 1202 located to the rear of the brush. The sweeper has a brush adjustment mechanism (not shown) that adjusts the vertical location of the brush relative to the ground or lawn. The brush has an arm 1208 connected to the frame. The connection of the arm to the receiver is similar to that of arm 540 including the locking mechanism 550. In one embodiment, the arm extends behind the hopper. When the sweeper is attached to the machine, the machine pushes the sweeper where the brush leads the hopper. The hopper is detachably connected to the sweeper.

A hitch 1300 is shown in FIG. 13. The hitch has a ball mount portion 1304. The ball 1306 comprises a ball portion 1308 and a stem portion (not shown) that extends through a hole in the ball mount portion. The stem is threaded and secured to the ball mount portion 1304 by a nut tightened against the bottom surface of the ball mount portion 1304. The ball mount portion is connected to an arm 1302. The connection of the arm to the receiver is similar to that of arm 540 including the locking mechanism 550. One skilled in the art will recognize that the receiver is capable of receiving other known hitch mounts, apart from the ball hitch described. When the hitch is attached to the machine at the receiver, the machine may be used to move trailers, boats, or other items adapted to connect to a hitch.

A lawn mower 1400 is shown in FIG. 14. The mower is the known type having wheels 1402 that force one or more blades 1406 to rotate when the mower 1400 is pushed forward and optionally backwards. The mover has a frame 1410 connected at opposite ends to a non-rotating portion of hubs 1408. The hub has a rotating portion that connects the wheels 1402 to the blades 1406. The wheel to blade connection may comprise gearing to provide a predetermined ratio of wheel turns to blade turns. The frame is connected to an arm 1412. The connection of the arm to the receiver is similar to that of arm 540 including the locking mechanism 550.

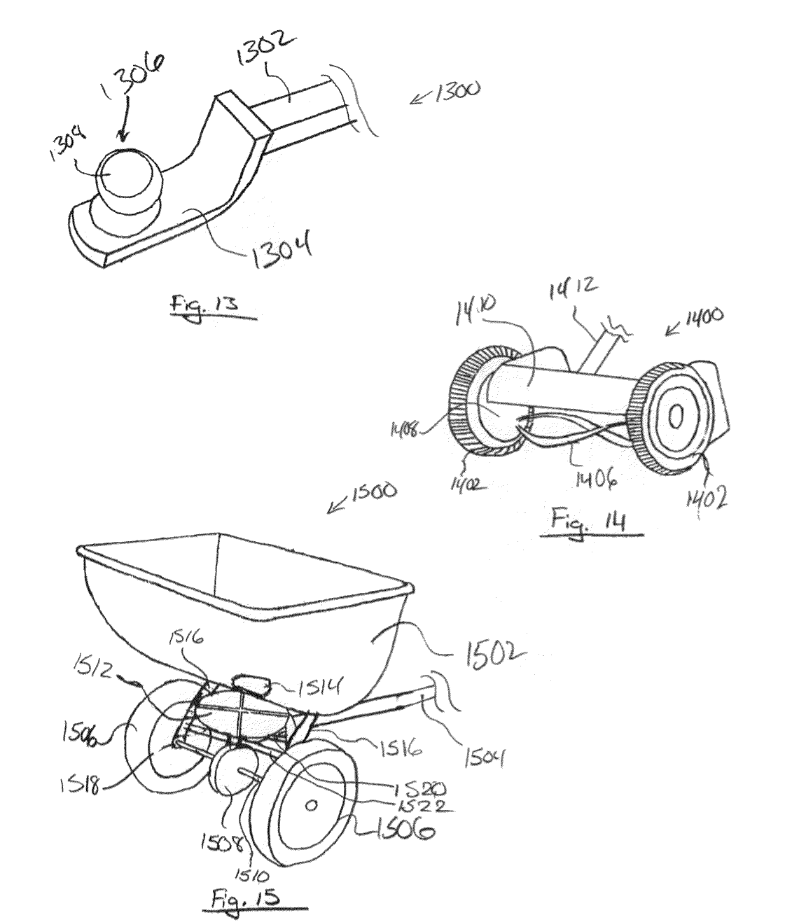

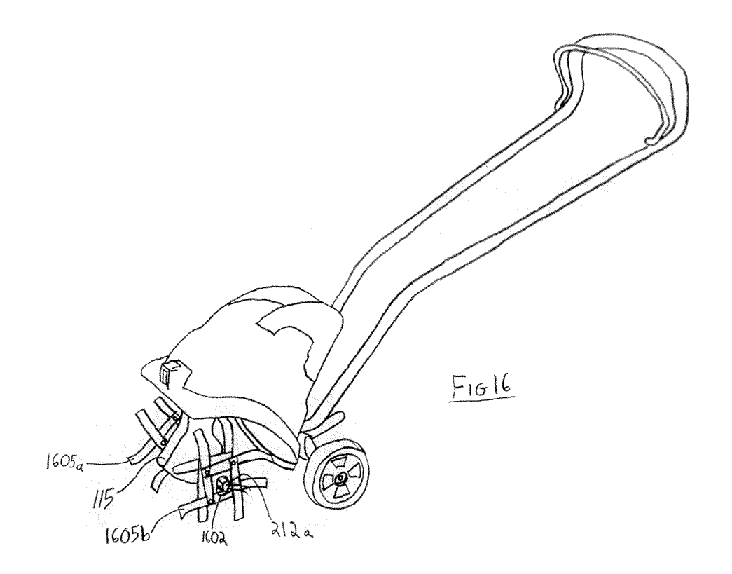

A spreader 1500 for spreading seed, fertilizer, and other pulverized material is shown in FIG. 15. In one embodiment, the spreader is that disclosed in U.S. Pat. No. 4,487,370, which is incorporated by reference. The spreader has a storage hopper 1502 and a spinning broadcast plate 1512 for distributing materials dropped from the hopper through the exit passage 1514. A valve (not shown) controls the flow of material through the exit passage 1514 to the broadcast plate 1512. An axle 1510 drives a gear 1508 that is connected thought gear linkage to rotate the plate 1512. The axle is driven to rotate by the wheels 1506. The hopper 1502 is connected by frame members 1516 to a hub mount 1518. A first cross member 1520 connects to the frame member 1516 and rotatably supports the plate 1512. A second cross member 1522 connected to the frame members below the first cross member 1502. The arm 1504 attached to the second cross member 1522. The connection of the arm to the receiver is similar to that of arm 540 including the locking mechanism 550. The receiver may also be connected to a wheel barrow, similar to spreader 1500 but having a hopper without an exit passage and without a broadcast plate.

In one embodiment, the wheels 502a, 502b of machine 500, 100 are removable. As shown in FIG. 16, tiller tines 1605a, 1605b are attachable to the drive shafts 212a, 212b and held onto the shafts by retaining pins 1602.

From the foregoing, it will be observed that numerous variations and modifications may be effected without departing from the spirit and scope of the invention. It is to be understood that no limitation with respect to the specific apparatus illustrated herein is intended or should be inferred.

I claim:

1. A user walk-behind self-propelled implement machine, comprising:
a frame having a front and a rear;
a motor connected to the frame and driving a pair of laterally spaced apart drive wheels through a gear box;
a receiver connected to a front portion of the frame in an area of the frame located between the drive wheels,
an implement detachably connected to the receiver; and
a handle connected to the frame and extending away from the rear of the frame.

2. The machine of claim 1, comprising at least one rear wheel located to the rear of the drive wheels, the at least one rear wheel connected to a height adjustment mechanism configured to adjust the vertical position of the implement.

3. The machine of claim 1, comprising at least two laterally spaced apart wheels located to the rear of the drive wheels.

4. The machine of claim 2, wherein the height adjustment mechanism is configured to pivot at least a portion of the frame about an axis of the drive wheels to adjust the vertical position of the implement.

5. The machine of claim 2, comprising a rear axle connected to a upwardly extending axle mount; wherein the at least one rear wheel comprises a pair of laterally spaced apart rear wheels connected to the axle, and the height adjustment mechanism comprises an axle mount receiver, the receiver comprises an lock for releasably securing the receiver along the axle mount.

6. The machine of claim 1, wherein the implement comprises a shovel.

7. The machine of claim 1, wherein the implement comprises a shovel, the shovel comprises an arm detachably connected to the receiver, a pivot mount, and pivotable blade; the pivot mount configured to locate the blade at one of a plurality of vertical positions about an vertical axis of connection between the pivot mount and the blade.

8. The machine of claim 7, wherein the arm has a blade mount opposite an end connected to the receiver, the blade mount comprises a plurality of blade mount holes, the pivot mount comprises at least one pivot mount hole aligned with one blade mount hole and a locking pin inserted through the aligned holes to secure the blade in one of said plurality of positions about the vertical axis of connection.

9. The machine of claim 7, wherein the blade has a centered position and a maximum pivotable range being 15 degrees in either direction from the center position.

10. The machine of claim 1, wherein the implement is a hitch.

11. The machine of claim 1, wherein the implement is an aerator.

12. The machine of claim 1, wherein the implement is a dethatcher.

13. The machine of claim 1, wherein the implement is a lawn sweeper.

14. The machine of claim 1, wherein the implement is a spreader.

15. The machine of claim 1, wherein the implement is a wheel barrow.

16. The machine of claim 1, wherein the implement is a lawn mower.

17. The machine of claim 1, wherein the implement is a sweeping brush having a rotator with bristles, and wherein the motor drives the rotator through a belt connected to the rotator.

18. The machine of claim 1, wherein the receiver comprises an anchor and a stop, and the implement comprises a latch configured to secure the implement to the receiver, the latch comprises a pivotable hook attached to a lever, the latch has a locked position, the lever engages the stop and the lever presses the hook into the anchor when the latch is in a locked position.

19. A user walk-behind self-propelled implement machine, comprising:
a frame having a front and a rear;
a motor connected to the frame and a driving through a gear box a pair of axes;
a part of rotators connected to the axes where the rotators are one of a pair of wheels or a pair of tiller tines;
a receiver configured to receive and implement and connected to a front portion of the frame in an area of the frame located between the axles; and
a handle connected to the frame and extending away from the rear of the frame.

20. A user walk-behind self-propelled implement machine, comprising:
a frame having a front and a rear;
a drive means for rotating a pair of laterally spaced apart drive wheels;
a receiver means for connecting an implement to the frame in an area of the frame located between the drive wheels;
an implement detachably connected to the receiver; and
a handle connected to the frame and extending away from the rear of the frame.
